(19) United States
(12) Patent Application Publication
(10) Pub. No.: US 2026/0326353 A1
(43) Pub. Date: Oct. 22, 2026

(54) TRANSFER DEVICE AND INJECTION MOLDING DEVICE

(71) Applicant: FOBOHA (Germany) GmbH, Haslach (DE)

(72) Inventors: Tobias GANTER, Wolfach (DE); Heinrich MUSER, Zell am Harmersbach (DE); Rainer ARMBRUSTER, Wolfach (DE)

(21) Appl. No.: 19/105,606

(22) PCT Filed: Jun. 27, 2023
(86) PCT No.: PCT/EP2023/067532

§ 371 Date: Feb. 21, 2025

(30) Foreign Application Priority Data
Aug. 22, 2022 (DE) 10 2022 121 184.3

(51) Int. Cl. B29C 45/73; B29C 45/04; B33Y 80/00

(52) U.S. Cl. CPC B29C 45/7312; B29C 45/045; B29C 2045/0458; B33Y 80/00

(57) ABSTRACT

In a preferred variation of the disclosure a transfer device is configured for transferring of fluids between a base and a central mold part arranged rotatably with respect to the base about a rotation axis in an injection molding device. Typically a column is arranged in a sleeve, said column and sleeve being arranged rotatable with respect to each other about the rotation axis. For good results, the sleeve comprises at least two annular segments arranged along the column in the direction of the rotation axis.

### FIELD OF THE DISCLOSURE

The present disclosure relates to a transfer device for transferring of fluids between a base and a central mold part in an injection molding device, and an injection molding device comprising such a transfer device.

### BACKGROUND OF THE DISCLOSURE

From the prior art devices for injection molding of plastic products are known, which comprise a first outer mold half and a second outer mold half arranged displaceable with respect to each other. Between the first and the second outer mold half a central mold part is arranged rotatable around a rotation axis extending typically in a vertical direction. The central part comprises typically at least two but more often four side faces which are arranged in pairs opposite to each other, each carrying an inner mold half.

During operation, the central mold part and the thereto attached inner mold halves must be supplied with various process fluids.

EP0922556A1 published in 1999 in the name of Foboha GmbH relates to a holding device for the injection mold halves or the supports thereof contain two displacing units. A rotating unit is placed on each of the said units. Holding means are located on each rotating unit. A die holder configured as a prismatic rotating block can be inserted in the interspace between both holding means. The die holder in the holding device can be displaced in a direction and can rotate around a displaceable axis which is vertical relative to said direction. Media are fed to the rotary block through channels or pipes in the first shaft and the second shaft of the axis.

WO2008043641A1 published in 2008 in the name of Krauss Maffei Tech GmbH relates to a turning device for a horizontal injection-moulding machine, comprising a base plate, on which a rotary table which can rotate about a vertical axis is arranged, and drive means for turning the rotary table. A rotary distributor or a rotary joint is described, which is used to convey a medium to the turntable or the mold halves.

WO2013001022A1 published in 2014 in the name of Foboha GmbH relates to a rotation device for rotating the center part in an injection-molding device. The rotation device comprises a column which is non-rotatably mounted in the interior of the center part and a sleeve surrounding the same which is mounted such as to rotate with the center part, said sleeve and said column being operatively interconnected via a drive.

WO2017210793A1 published in December 2017 in the name of Athena Automation Ltd. relates to an injection molding machine including a stationary platen and a moving platen mounted on a machine base and a rotary apparatus for rotatably supporting a center mold section. The rotary apparatus includes a rotary table mounted atop the carriage body rotatable relative to the carriage body about a vertical table axis for rotatably supporting the center mold assembly; and a rotary union housed in the carriage body beneath the rotary table and above the actuator connection portion, the rotary union fixed to rotate with the table about the table axis.

WO2020025361A1 published in 1999 in the name of Foboha GmbH relates to an injection molding device including a center part and a rotating device for rotating the center part in the injection molding device. The rotating device includes a base supported with respect to an injection molding machine. A thereto attached column extends in an axial direction above the base. A sleeve coaxially surrounds the column and is at least partially arranged in the center part. The sleeve rotates with the center part around the column. The column is arranged removable with respect to the center part.

### SUMMARY OF THE DISCLOSURE

To supply a central mold part with various process fluids such as cooling water, hydraulic oil, pneumatic air or a selection thereof, special devices are required. The known devices are typically unique parts for a specific injection molding device and a specific application, leading to high manufacturing costs and generally a low degree of standardization. In addition, these parts need to be maintained frequently. This can only be achieved by time consuming disassembly of these complex devices, which is a drawback as down time, has a negative impact on the operation cost of the device.

In a preferred variation of the disclosure a transfer device is configured for transferring of fluids between a base and a central mold part arranged rotatably with respect to the base about a rotation axis in an injection molding device. Typically a column is arranged in a sleeve, said column and sleeve being arranged rotatable with respect to each other about the rotation axis. For good results, the sleeve comprises at least two annular segments arranged along the column in the direction of the rotation axis. In the mounted position, at least two annular segments can be arranged adjacent to each other, each being configured to exchange fluids with the therein arranged column as described herein. Preferably the at least two annular segments each encompass a section of the column. The at least two annular segments of the sleeve are typically arranged coaxially with the column. This allows an improved disassembly of the sleeve by removing the necessary segments in a sequential manner. Also the assembly is improved, as the segments of the sleeve are mountable onto the column one by one. In addition, having a sleeve comprising at least two annular segments reduces the length (depth) along a central axis of an individual annular segments compared to an integral sleeve of the combined length. The machining of (shorter) individual segments is simplified and/or is feasible with less complex and costly tools.

Depending on the application, the sleeve comprises three or four or five or six, or more segments for exchanging of fluids. If appropriate, the segments of the sleeve can be interconnected to each other in a detachable manner. Depending in the field of application at least two segments can be interconnected to each other in a non-detachable manner, e.g. by welding or shrink-fit or a combination thereof.

If appropriate, at least two of the segments are of an identical design, promoting standardization. A sleeve comprising two or more annular segments can be assembled from standardized (and pre-manufactured) segments. In case part of the sleeve is worn out, only the affected segments need to be replaced (with available replacement segments). This is advantageous over the prior art, where the whole sleeve had to be replaced.

Preferably at least one annular segment is configured to transfer at least one fluid between the column and the annular segment. As mentioned herein, the at least one fluid can be a liquid, such as cooling water or hydraulic oil, or a gas such as pneumatic air or a selection thereof.

Typically the annular segments comprise a side wall extending between a first end-face and a second end-face for connecting to a neighboring segment respectively. Said side wall encloses on its inside an opening configured to receive the column. The side wall can have various shapes, such as cylindrical or rectangular or polygonal, in particular it can have a rectangular shape with rounded edges. The outer side wall is preferably shaped such that the annular segment can be easily clamped during production.

In some variations, one or more segments are of a compact design. Here the height of at least one of the annular segments (along the central axis of a segment) is less than its width (perpendicular to the central axis of a segment). Depending on the design of the column, the height of an individual segment is preferably less than half the height of the column (along the axis of rotation), more preferably less than a third or a quarter of the height of the column.

If appropriate, at least one of the annular segments is manufactured by an additive process. However, a machining thereof from a solid material, in particular metals such as steel or aluminum, is possible as well.

In some variations at least one groove is arranged between the sleeve and the column for transferring of at least one fluid there between. In a preferred variation, at least one annular segment comprises at least one first groove facing in a mounted position the column for the transfer of at least one fluid therebetween. Alternatively or in addition, the column comprises at least one (corresponding) groove facing in a mounted position a segment of the sleeve for the transfer of at least one fluid therebetween. The first groove of the segment typically forms in the mounted position with the column a fluid interface. In preferred variations, the at least one first groove has a height (extension parallel to the central axis of the annular segment) greater than its width (extension perpendicular to the central axis of the annular segment, ie. radial thickness).

Depending on the design, the at least one first groove is a circumferential groove. Alternatively, the at least one first groove can be a section circumferential groove, which encompasses the column in the assembled state only partially. This allows to transfer fluids between the column and the sleeve in an angle dependent manner, wherein only in some rotational orientations (angles) of the sleeve relative to the column, a transfer therebetween is possible.

In a preferred variation at least one annular segment comprises two or more first grooves for transferring of fluids between the segment and the column. A pair of first grooves can implement an inlet and outlet of a fluid circuit of the central mold part. The pair of first grooves is preferably arranged in a common segment of the sleeve, however a separate arrangement is possible as well.

In order to transport the at least one fluid between the sleeve and the central mold part, the column preferably comprises at least one channel extending in a longitudinal direction of the column for transfer of a fluid. Typically the column comprises one channel per first groove on the sleeve.

If appropriate, at least one segment comprises a passage for fluidly interconnecting the first groove across the segment to a fluid circuit. In some variations the passage extends at least partially parallel to a central axis of the at least one segment fluidly interconnecting the first groove to an outside of the segment. Alternatively or in addition, the passage extends at least partially perpendicular to a central axis of the at least one segment fluidly interconnecting the first groove to the passage of a neighboring segment. Preferably, the passage is in sections formed as a channel inside the side wall. In particular, the passage may extend from a connector arranged at an outer surface of the side wall of the segment to the first groove on an inside of the side wall. Alternatively or in addition, the at least one passage may discharge into the first and/or the second end face of the segment. Preferably the segment comprises a sealing arranged at a discharge opening of the passage at the respective end face for fluidly interconnecting the passage to a passage of a neighboring segment or the central mold part in a sealed manner.

For good performance, at least one annular segment comprises at least one second groove configured to receive a sealing ring. The sealing ring arranged in the at least one second groove forms during operation a sealed connection between the column and the segment, such that the leakage from the first groove is minimized or even prevented. Typically at least one second groove is arranged between two neighboring first grooves, in some variations two second grooves are arranged between neighboring first grooves. Preferably the number of second grooves of at least one segment is one more than the number of first grooves of the same segment. The sealing ring can be formed as an o-ring made from an elastic material such as rubber.

In a preferred variation, at least two neighboring annular segments are interconnected with respect to each other in a form fit manner. Preferably at least two annular segments each comprise a first interface and a matching second interface for connecting the at least two annular segments in a standardized manner to each other. Depending on the design, the first interface of an annular segment can form with the corresponding second interface of a neighboring annular segment a form-fit connection. In some variations the first and/or the second interface are essentially rotationally symmetric with respect to the central axis of the respective annular segment. In other variations, the first and/or the second interface comprise anti-rotation means for orienting two neighboring annular segments with respect to each other. The anti-rotation means can be formed as pin or the like, preferably the anti-rotations means are formed as a rotationally unsymmetrical shape of the first and the second interface. If appropriate, the first interface of an annular segment overlaps in the assembled state with the corresponding second interface of a neighboring annular segment along the direction of the axis of rotation. The overlap is preferably less than a tenth of the height of the two neighboring segments.

Depending of the field of application, the segments can comprise a first alignment surface engaging in an assembled state with a second alignment surface of the neighboring segment to align the two neighboring segments concentrically. The first alignment surface is preferably arranged at a protrusion of the first and/or second end-face and/or extending in the assembled state at least partially into a corresponding recess arranged at the first and/or second end-face, wherein the second alignment surface is arranged in the recess. The protrusion can form in this case part of the first interface and the corresponding recess can form part of the second interface. This allows to connect at least two annular segments in an arbitrary sequence in a standardized manner. If appropriate the protrusion is an annular protrusion arranged concentrically with the opening of the segment, preferably the annular protrusion is formed as a bead. Correspondingly, the recess is an annular recess arranged concentrically with the opening of the segment, in particular the annular recess can be formed as a step at the opening of the segment. To prevent a tilted contact of two neighboring segments, the first and the second end-face each comprise an essentially planar contact surface, in particular an annular contact surface. Preferably at least two neighboring segments are pressed against each other with their respective contact surfaces in the assembled state. If appropriate, a second groove is arranged next to the first interface and another second groove is arranged next to the second interface. In other versions a second groove is at least partially integrated into the first and/or the second interface.

Good results can be achieved, when two neighboring segments are releasably or fixedly interconnected to each other in the assembled state. A fixed interconnection can be realized by welding and/or shrink-fitting two segments together before or in the assembled position. In a preferred variation the segments are releasably interconnected using screws or other attachment means. This allows for clamping the segments with respect to each other, for increased rigidity of the sleeve and minimized potential for leakage. If appropriate, at least one screw is accessible in the assembled state from the outside. The screw head is preferably arranged in a cutout, in particular in a lateral cutout. This may allow to separate part of the sleeve in the assembled state, wherein the separated part typically comprises one or more annular segments.

Depending on the construction, the annular segments have a substantially identical or congruent contour in a cross-sectional view. This promotes an interchangeability of the segment, further increasing the standardization. In particular, the sleeve has an outer surface being at least in parts substantially parallel to the column.

To ensure a good rotatability of the sleeve and the column with respect to each other, at least one annular segment comprises a bearing on the inside to center the column with respect to the annular segment. Preferably, the at least one segment comprising the bearing is formed as a terminal segment configured to receive an end section of the column. If appropriate, the terminal segment comprises a sidewall encircling an opening and a bottom forming with the side wall a recess to accommodate the end section of the column therein. In some variations the bottom of the terminal segment comprises a projection extending in the mounted position into a corresponding indentation of the column. For good performance the at least one annular segment comprises a rotation and/or position sensor for measuring the orientation (angel) of the column with respect to the sleeve. Preferably the projection is arranged concentrically with the column and houses the rotation and/or position sensor.

Good results can be achieved when the column along its axial direction has a variable diameter. Depending on the design the variable diameter can be e.g. linearly varying. Alternatively, or in addition the column may have a staggered design with a diameter decreasing in steps along its general extension. This allows a simplified assembly of the transfer device. Preferably a column with a staggered design comprises at least two sections arranged coaxially and adjacent to each other with respect to a axial direction of the column.

In some variations, the column is of multipart design with at least two segments arranged coaxially and adjacent to each other with respect to the axial direction of the column. Between the at least two segments sealing rings and or fluid couplings are arranged for connecting the corresponding channels of the two segments in a sealing manner. Similar advantages with respect to standardization and maintainability can be realized this way.

Depending on the field of application, the column is arranged stationary with respect to the base and the sleeve is arranged in the mold central part. The column is here usually arranged removable with respect to the center part. In a preferred variation the column is interconnectable to the base, in particular in a detachable manner.

Alternatively, the sleeve is arranged stationary with respect to the base and the column is arranged outside of the central mold part stationary with respect to the central mold part.

In another preferred variation of the disclosure, an injection molding device comprises a transfer device as described herein. Said transfer device fluidly interconnects a base and a central mold part arranged rotatably with respect to the base about a rotation axis.

Depending on the design, the transfer device is attached to the base. In some variations the transfer device is at least partially incorporated into the central mold part. In a preferred variation, the transfer device is attached to a lower face of the base protruding away from the base, while the central mold part is during operation mounted onto an upper face of the base, opposite of the lower face.

The injection molding device preferably comprises at least one outer mold half. The central mold part and the at least one outer mold half are typically arranged displaceable with respect to each other between an open and a closed position. In a preferred variation the molding device preferably comprises a first and a second outer mold half arranged opposite with respect to the central mold part. Each outer mold half forms in the closed position with respective inner mold halves arranged at the central mold part cavities suitable to receive melted plastic material injected through a sprue channel into the cavities to form objects consisting at least partially from the melted plastic material. After the melted plastic material has sufficiently cured, the injection molding device is opened and the center part is rotated by an appropriate angle, usually about at least 90 degrees, around the rotation axis such that another two inner mold halves can be interconnected to the first and the second outer mold half forming cavities therebetween.

If appropriate, the column protrudes at least partially through an opening of the base. In some variations, the column extends through an opening of the central part. Here it is possible to arrange at least one segment of the sleeve around a first end of the column and at least one segment of the sleeve around an opposite second end of the column, while the central mold part is arranged interposed between the at least two segments of the sleeve.

A gear for driving the central mold part preferably encompasses the column. The gear is in some variations attached to a coupling plate detachably connected to the central mold part. The coupling plate is usually arranged concentric to the opening of the base and rotatable with respect to the base about the rotation axis. Depending on the field of application, either the column or the sleeve is attached to the coupling plate for rotating therewith during operation. Preferably the coupling plate is rotatably mounted on a base plate of the base by means of bearings arranged therebetween.

A lightweight construction is possible, when the base comprises a base plate being made at least partially by an additive manufacturing process. The base plate is preferably at least partially made from metal, however other materials such as composite materials are possible as well.

For good performance, the column is supported during operation by the coupling plate for the central mold part, said coupling plate being arranged rotatably about the axis of rotation on the base.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings are showing:

FIG. 1 a first variation of an injection molding device according to the disclosure;

FIG. 2 a partially sectioned view of a first variation of a transfer device according to the disclosure;

FIG. 3 an exploded and partially sectioned view of the transfer device of FIG. 2;

FIG. 4 a detailed view of the transfer device of FIG. 2, indicated in FIG. 2 by box with label A; and

FIG. 5 a detailed view of the transfer device of FIG. 4, indicated in FIG. 4 by circle with label R

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

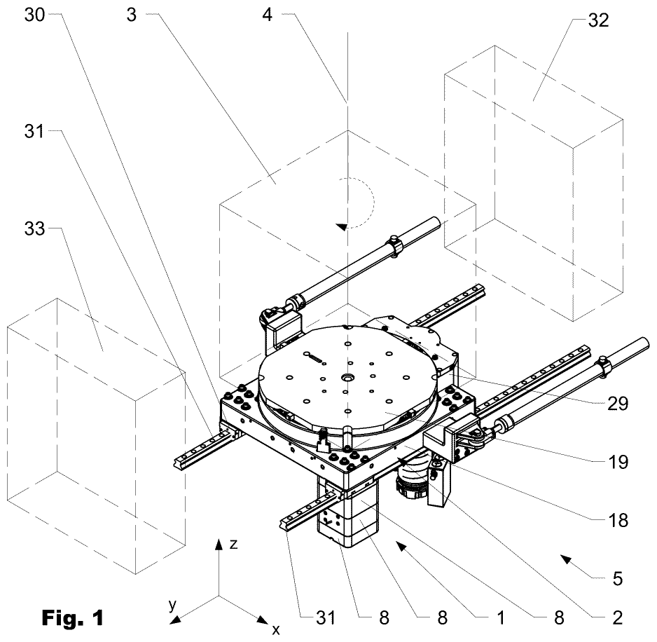

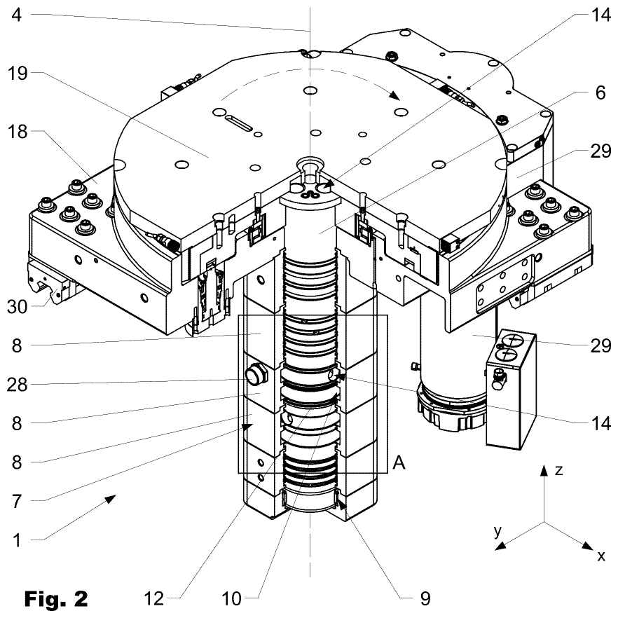

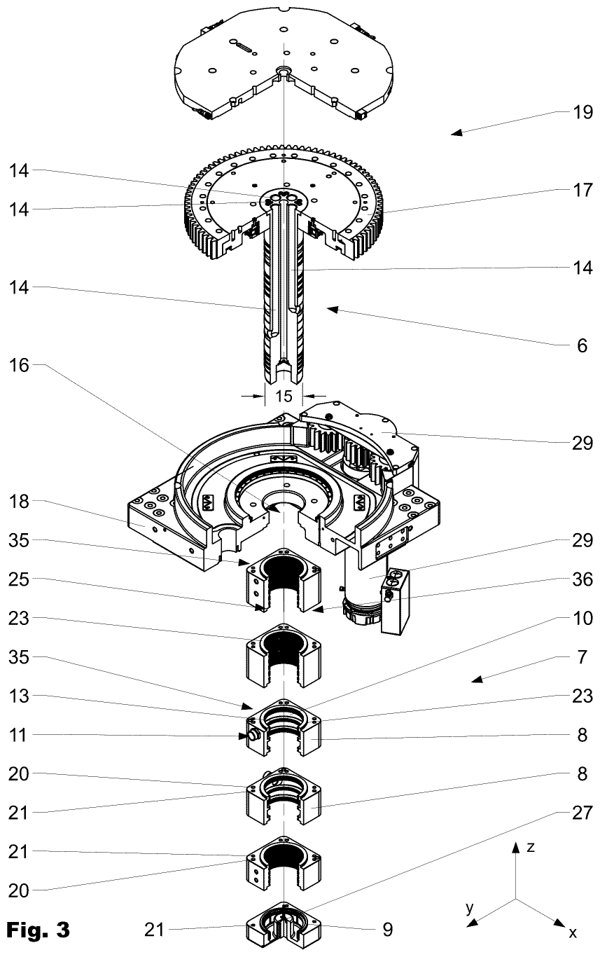

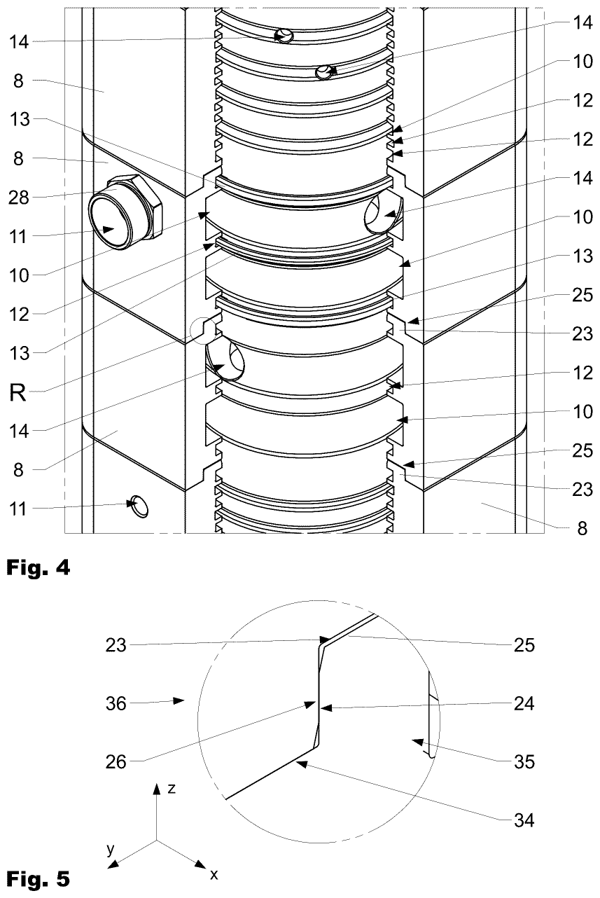

FIG. 1 shows a first variation of an injection molding device 5 according to the disclosure. In FIG. 2 a partially sectioned view of a first variation of a transfer device 1 according to the disclosure is shown and FIG. 3 shows an exploded and partially sectioned view of the transfer device 1 of FIG. 2. FIG. 4 shows a detailed view of the transfer device 1 of FIG. 2, indicated in FIG. 2 by box with label A and in FIG. 5 a detailed view of the transfer device 1 of FIG. 4, indicated in FIG. 4 by circle with label R can be seen.

The first variation of the injection molding device 5, as displayed in FIG. 1, comprises a transfer device 1 fluidly interconnecting a base 2 and a central mold part 3 arranged rotatably with respect to the base 2 about a rotation axis 4. Arranged along a first direction y on opposite sides of the central mold part 3 are a first outer mold half 32 and a second outer mold half 33. In the shown variation the first mold half 32 is stationary during operation, while the central mold part 3 and the second outer mold half 33 are arranged displaceable along the first direction y between an open and a closed position. In the closed position inner mold halves (not shown) arranged at the central mold part 3 from cavities with the first and the second outer mold half 32, 33 suitable to receive melted plastic material injected through a sprue channel into the cavities to form objects consisting at least partially from the melted plastic material. After the melted plastic material has sufficiently cured, the injection molding device 5 is opened the center part 3 is rotated by an appropriate angle, usually by at least 90 degrees, around the rotation axis 4, such that another two inner mold halves can be interconnected to the first and the second outer mold half 32, 33 forming cavities therebetween. A drive 29 is attached to the base 2 driving the rotation of the central mold part 3. The transfer device 1 is attached to a lower face of a base 2. The base 2 supports the central mold part 3 during operation and is displaceable in the first direction y. For this reason, linear guides 30 attached to the base 2 allow a linear displacement on rails 31 when moved between the open and the closed position.

As visible in FIG. 2, the transfer device 1 comprises a column 6 arranged in a sleeve 7. In the shown variation, the sleeve 7 is attached to a base plate 18 of the base 2. The column 6 is interconnected to the central mold part 3 via a coupling plate 19, thus the column 6 rotates with the central mold part 3 during operation. The coupling plate 19 is arranged concentric to an opening 16 of the base 2 and rotatable with respect to the base 2 about the rotation axis 4. A possible direction of rotation is indicated by the dashed arrow. A gear 17 is attached to the coupling plate 19, said gear 17 mechanically interconnects the coupling plate 19 to the drive 29 for rotating the coupling plate 19. In the shown variation, the column 6 extends though the opening 16 of the base 2 and is fluidly interconnectable to the central mold part 3 via the coupling plate 19. For increased maintainability, the sleeve 7 comprises at least two annular segments 8 arranged along the column 6 in the direction of the rotation axis z. The sleeve 7 of the shown first variation of the transfer device 1 has a total of six annular segments 8 stacked in the direction of the rotation axis z. At least one of the annular segments 8 is configured to transfer at least one fluid between the column 6 and the annular segment 8. Typically this fluid is cooling water or hydraulic oil, or a gas such as pneumatic air or a selection thereof.

The segments 8 typically comprise a side wall extending between a first end-face and a second end-face for connecting to a respective neighboring segment 8. Said side wall encloses on its inside an opening configured to receive the column 6. Here the side wall has a rectangular outer shape with rounded edges. This is best visible in FIG. 3. A terminal segment 8 is configured to receive an end section of the column 6 and comprises a bearing 9 on the inside to center the column 6 with respect to the annular segment 8. The terminal segment 8 comprises a sidewall and a bottom forming with the side wall a recess to accommodate the end section of the column therein. Here the bottom of the terminal segment 8 comprises a projection extending in the mounted position into a corresponding indentation of the column 6. The projection is arranged concentrically with the column 6 and houses a rotation and/or position sensor 27.

As best visible in FIG. 4, at least one segment 8 comprises a first groove 10 facing in a mounted position the column 6 for the transfer of at least one fluid therebetween. In the shown variation each segment 8, except for the terminal segment 8, comprises two or four first grooves 10. Between neighboring first grooves 10, at least one second groove 12 is arranged being configured to receive a sealing ring 13. This way it can be ensured to minimize leakage between two neighboring first grooves 10. The sealing rings 13 are formed as o-rings, made from an elastic material. At least one passage 11 per segment 8 is configured to fluidly interconnect the first groove 10 across the segment 8 to a fluid circuit. The shown passages 11 each extend from a connector 28 arranged at an outer surface of the side wall of the segment 8 to the first groove 10 on an inside of the side wall.

The column 6 comprises least one channel 14 extending in a longitudinal direction z of the column 6 for transfer of a fluid, in particular between the respective first groove 10 and the central mold part 3. In the shown variation, the column 6 comprises per first groove 10 a channel 14. Each channel 14 comprises an opening facing in the assembled state the respective first groove 10.

At least two neighboring annular segments 8 are interconnected with respect to each other in a form fit manner. FIG. 5 shows a detailed view of a border region between two neighboring segments 8. The lower segment 8 comprises a protrusion 23 extending in the assembled state at least partially into a corresponding recess 25 of the upper segment 8. Here a first alignment surface 24 arranged at the protrusion 23 engages in an assembled state with a second alignment surface 26 arranged at the recess 25 for aligning the upper and the lower segment 8 concentrically with respect to each other. The segments 8 are pressed against each other at contact surfaces 34. As visible in FIG. 3 the protrusion 23 and the first alignment surface arranged thereon form a first interface 35 and the recess 25 having the second alignment surface 26 arranged therein form a second interface 36. In the shown variation, each of the annular segments 8 comprises a substantially identical first interface 35 arranged at a first end-face and a substantially identical second interface 36 arranged at a second end-face being opposite to the first end-face. This allows for stacking arbitrary segments 8 onto each other with corresponding interfaces 35, 36 engaging to form a connection, in particular a form fit connection therebetween. As can be seen in FIG. 4, typically a second groove 12 is arranged next to the first interface 35 and another second groove 12 is arranged next to the second interface 36.

As shown in FIG. 4, the segments 8 are detachably interconnected to each other in the assembled state. Each segment 8 comprises in the shown variation at least one through-bore 21 for receiving a screw 22 (with the screw head) and a bore 20 for receiving the threaded end of a screw 22 of a neighboring segment 8. The screws 22 are used to clamp two neighboring segments 8 against each other's contact surface 34.

Rather, the words used in the specification are words of description rather than limitation, and it is understood that various changes may be made without departing from the scope of the disclosure.

LIST OF DESIGNATIONS

| | |
|---|---|
| 1 | Transfer device |
| 2 | Base |
| 3 | Central mold part |
| 4 | Axis of rotation |
| 5 | Injection molding device |
| 6 | Column |
| 7 | Sleeve |
| 8 | Segment (sleeve) |
| 9 | Bearing |
| 10 | First groove |
| 11 | Passage |
| 12 | Second groove |
| 13 | Sealing ring |
| 14 | Channel |
| 15 | Diameter (column) |
| 16 | Opening (base) |
| 17 | Gear |
| 18 | Base plate (base) |
| 19 | Coupling plate |
| 20 | Bore (segment) |
| 21 | Through-bore (segment) |
| 22 | Screw (segment) |
| 23 | Protrusion |
| 24 | First alignment surface (protrusion) |
| 25 | Recess |
| 26 | Second alignment surface (recess) |
| 27 | Sensor (terminal segment, sleeve) |
| 28 | Connector (passage) |
| 29 | Drive (coupling plate) |
| 30 | Linear guide (base) |
| 31 | Rail |
| 32 | First outer mold half |
| 33 | Second outer mold half |
| 34 | Contact surface |
| 35 | First interface |
| 36 | Second interface |

1. Transfer device (1) for transferring of fluids between a base (2) and a central mold part (3) arranged rotatably with respect to the base (2) about a rotation axis (4) in an injection molding device (5), wherein:
a. a column (6) is arranged in a sleeve (7), said column (6) and sleeve (7) being arranged rotatable with respect to each other about the rotation axis (4), and
b. the sleeve (7) comprises at least two annular segments (8) arranged along the column (6) in the direction of the rotation axis (4).

2. The transfer device (1) according to claim 1, wherein at least one annular segment (8) is configured to transfer at least one fluid between the column (6) and the annular segment (8).

3. The transfer device (1) according to claim 1, wherein at least one annular segment (8) comprises a bearing (9) on the inside to center the column (6) with respect to the annular segment (8).

4. The transfer device (1) according to claim 1, wherein at least one annular segment (8) comprises at least one first groove (10) facing in a mounted position the column (6) for the transfer of at least one fluid therebetween.

5. The transfer device (1) according to claim 4, wherein at least one segment (8) comprises a passage (11) for fluidly interconnecting the first groove (10) across the segment (8) to a fluid circuit.

6. The transfer device (1) according to claim 5, wherein the passage (11) extends at least partially parallel and/or at least partially perpendicular to a central axis of the at least one segment (8) fluidly interconnecting the first groove (10) to an outside of the segment (8) and/or to the passage of a neighboring segment (8).

7. The transfer device (1) according to claim 4, wherein the annular segment (8) comprises at least one second groove (12) configured to receive a sealing ring (13).

8. The transfer device (1) according to claim 1, wherein at least two neighboring annular segments (8) are interconnected with respect to each other in a form fit manner.

9. The transfer device (1) according to claim 1, wherein at least two annular segments (8) each comprise a first interface (35) and a matching second interface (36) for connecting the at least two annular segments (8) in a standardized manner to each other.

10. The transfer device (1) according to claim 1, wherein the column (6) is arranged stationary with respect to the base (2) and the sleeve (7) is arranged in the mold central part.

11. The transfer device (1) according to claim 1, wherein the sleeve (7) is arranged stationary with respect to the base (2) and the column (6) is arranged outside of the central mold part (3) stationary with respect to the central mold part (3).

12. The transfer device (1) according to claim 1, wherein the column (6) comprises at least one channel (14) extending in a longitudinal direction of the column (6) for transfer of a fluid.

13. The transfer device (1) according to claim 1, wherein the column (6) has a staggered design with a diameter (16) decreasing in steps along its general extension.

14. Injection molding device (5) comprising a transfer device (1) according to claim 1 fluidly interconnecting a base (2) and a central mold part (3) arranged rotatably with respect to the base (2) about a rotation axis (4).

15. The injection molding device (5) according to claim 14, wherein the column (6) protrudes at least partially through an opening (16) of the base (2).

16. The injection molding device (5) according to claim 14, wherein a gear (17) for driving the central mold part (3) encompasses the column (6).

17. The injection molding device (5) according to claim 14, wherein the base (2) comprises a base plate (18) being made at least partially by an additive manufacturing process.

18. The injection molding device (5) according to claim 14, wherein the column (6) is supported during operation by a coupling plate (19) for the central mold part (3), said coupling plate (19) being arranged rotatably about the axis of rotation on the base (2).
